(19) United States
(12) Patent Application Publication
(10) Pub. No.: US 2017/0218606 A1
(43) Pub. Date: Aug. 3, 2017

(54) ACTIVATION DEVICE FOR AN ELECTONIC FAUCET

(71) Applicants: Hsiang-Hung Wang, Changhua (TW); Yu-Chang Lin, Changhua (TW)

(72) Inventors: Hsiang-Hung Wang, Changhua (TW); Yu-Chang Lin, Changhua (TW)

(21) Appl. No.: 15/008,448

(22) Filed: Jan. 28, 2016

(51) Int. Cl. E03C 1/05; F16K 31/06

(52) U.S. Cl. CPC E03C 1/055; F16K 31/06

(57) ABSTRACT

An activation device for an electronic faucet comprises a body, a shell, and a battery. It is further characterized in that a wireless transmission module is arranged at the shell and electrically connected with the battery pack. The wireless transmission module has an activation switch which has a timer to be set to turn on/off the wireless transmission module. Therefore, the wireless transmission module may be not continuously operated so as to effectively reduce the power loss.

### FIELD OF THE INVENTION

The present invention relates to a faucet, and more particularly to an activation device of an electronic faucet.

### DESCRIPTION OF THE PRIOR ART

The water resources are more and more important following the environmental development and the national development. The uneven rainfall is caused by the climate change. Each country I the world is confronted the problem which is how to effectively store and economize the use of the water resources. The conventional faucet is mainly turned on/off manually. Although it is not necessary to turn on/off the faucet with any power, it may be indirectly caused the waste of the water resources due to human carelessness. In order to solve the problem of the conventional faucet, there are many sensing faucet arranged in public facilities. The sensing faucet is used the reflection of the infrared ray. An user puts his/her hand(s) under the faucet and then the infrared ray is emitted from an infrared transmitting tube of a sensor to the hand(s) of the user and reflected back to the infrared transmitting tube. After the reflection signal is processed, an electromagnetic valve starts to provide water. After the hand(s) is/are left the sensor of the faucet, the reflection of the infrared ray is not happened and then the electromagnetic valve does not provide water. It may effectively save the water resources and reduce the germs remained at the faucet when the user directly touch the faucet.

Furthermore, please reference to U.S. Pat. No. 9,049,821, an electronic faucet controlled by a mobile device is developed. The electronic faucet has a wireless transmission module for receiving, transmitting, and processing the wireless signals from the mobile device to provide to control the water flow through a bridge device, a solenoid valve checked if blocking up, or user's habits of the electronic faucet. However, the sensor and the solenoid valve of the above mentioned conventional electronic faucet must be operated all day long. The wireless transmission module is also needed to consume electrical power. Therefore, the battery providing power to the electronic faucet must be replaced frequently. The replacement of the battery may increase cost and make the use inconvenient. The replaced battery is not environment friendly.

### SUMMARY OF THE INVENTION

A main object of an activation device for an electronic faucet in accordance with the present invention is to solve the above mentioned problems. A switch is arranged at one side of the electronic faucet. The switch has a timer. A wireless transmission module is turned on by pressing the switch to achieve the effect of power saving.

The activation device for an electronic faucet, comprising a body, having an inlet pipe arranged thereinside, and the inlet pipe has an electromagnetic valve; a shell, having an outlet pipe fluidly communicated with the inlet pipe, a sensor is arranged at the shell and electrically connected with the electromagnetic valve to be controlled to turn on/off; and a battery pack, provided a power to the sensor and the electromagnetic valve; further characterized in that: a wireless transmission module is arranged at the shell and electrically connected with the battery pack, the wireless transmission module has an activation switch, the activation switch has a timer to be set to turn on/off the wireless transmission module. Therefore, the wireless transmission module may be not continuously operated so as to effectively reduce the power loss.

There are many effects of the present invention described as follows.

The wireless transmission module has the activation switch which is capable for turning off the wireless transmission module to transmit in a setting time so as to effectively reduce the electrical power loss.

The wireless transmission module may be communicated with the mobile device. The functions of the electronic faucet may be controlled to set by the mobile device, such as the quantity of water or the filter checked if blocking up.

The wireless transmission module has a storage unit to provide to record the user's habits and then transmit the information to the mobile device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a system diagram of an activation device for an electronic faucet in accordance with the present invention;

FIG. 2 is a circuit block diagram of the activation device in accordance with the present invention; and

FIG. 3 is an operational view of the activation device in accordance with the present invention.

### DETAILED DESCRIPTION OF THE PREFERRED EMBODIMENT

To describe clearly that the present invention achieves the foregoing objective and function, the technical features and desired function are described with reference to a preferred embodiment and accompanying drawings.

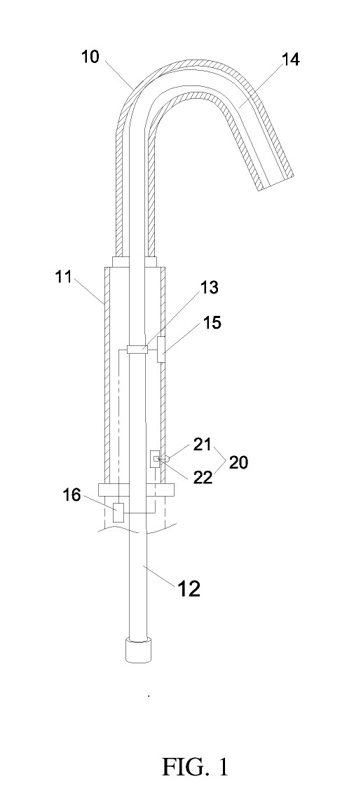

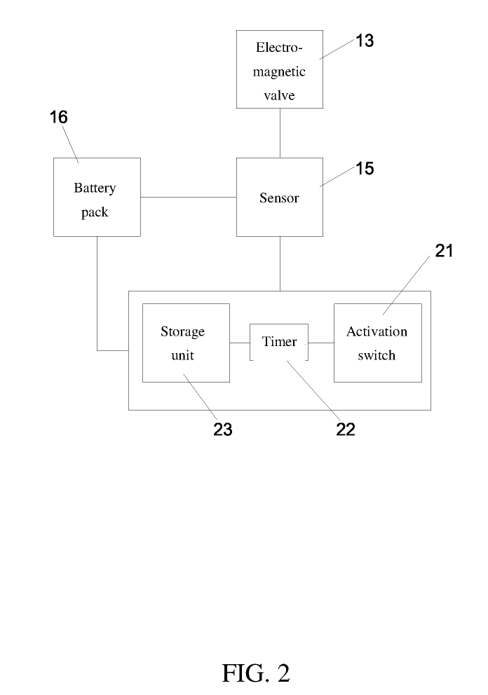

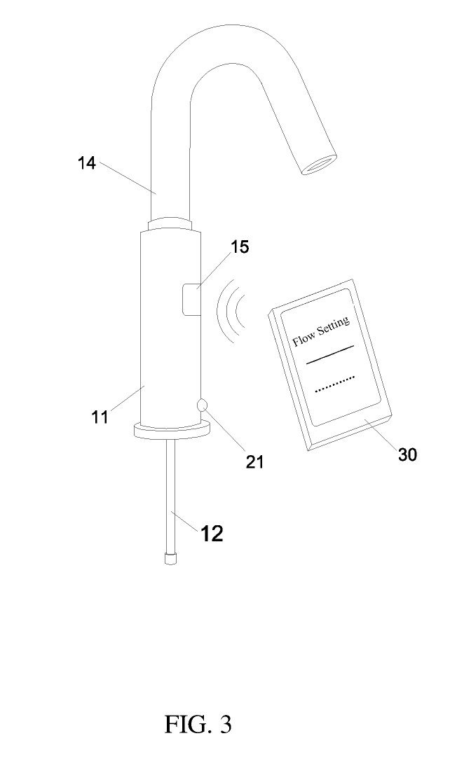

Please refer to FIGS. 1 to 3, an activation device for an electronic faucet may mainly comprise a body 10, a shell 11, and a battery pack 16.

The body 10 has an inlet pipe 12 arranged thereinside. The inlet pipe 12 has an electromagnetic valve 13. The shell 11 has an outlet pipe 14 fluidly communicated with the inlet pipe 12. A sensor is arranged at the shell 11 and electrically connected with the electromagnetic valve 13 to be controlled to turn on/off. The battery pack 16 is provided a power to the sensor 15 and the electromagnetic valve 13.

It is further characterized in that a wireless transmission module 20 is arranged at the shell 11 and electrically connected with the battery pack 16. The wireless transmission module 20 has an activation switch 21. The activation switch 21 has a timer 22 to be set to turn on/off the wireless transmission module 20 so as to effectively reduce the electrical power loss.

Therefore, the activation device for the electronic faucet of the present invention may have following effects.

Please refer to FIGS. 1 to 3, when an user wants to set the functions of the faucet, the activation switch 21 is pressed to turn on the wireless transmission module 20 to transmit, receive, or process a setting order from a mobile device 30. Because the activation switch 21 has the timer 22, the activation switch 21 is automatically turned off the wireless transmission module 20 to transmit while a setting time is up. The user may press the activation switch 21 again, or does not care about it to make the activation switch 21 automatically turn off the wireless transmission module 20 so as to reduce the electrical power loss.

In the above mentioned embodiment, the wireless transmission module 20 and the electromagnetic valve 13 are electrically connected with each other. A size of a diameter of the electromagnetic valve 13 while being turned on is set by the user with the mobile device 30 so as to control a water flow.

In the above mentioned embodiment, the wireless transmission module 20 and the sensor 15 are electrically connected with each other. The wireless transmission module 20 has a storage unit 23. The storage unit 23 is recorded the user's habits, such as washing time and the quantity of water for each washing. The information recorded by the storage unit 23 is transmitted to the mobile device 30 of the user to provide to analyze so as to adjust the relative parameters of the electronic faucet.

In the above mentioned embodiment, the activation switch 21 may be selected to a reed switch or an electronic switch to turn on the wireless transmission module 20.

In conclusion, the wireless transmission module 20 and the activation switch 21 are integrated with each other. The timer 22 of the activation switch 21 is provided to set to turn on/off the wireless transmission module 20. Therefore, the wireless transmission module 20 may not be operated continuously so as to effectively reduce the electrical power loss.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. An activation device for an electronic faucet, comprising a body, having an inlet pipe arranged thereinside, and the inlet pipe has an electromagnetic valve; a shell, having an outlet pipe fluidly communicated with the inlet pipe, a sensor is arranged at the shell and electrically connected with the electromagnetic valve to that the electromagnetic valve is controlled by the sensor to turn on/off; and a battery pack, provided a power to the sensor and the electromagnetic valve; further characterized in that:
a wireless transmission module is arranged at the shell and electrically connected with the battery pack, the wireless transmission module has an activation switch, the activation switch has a timer to be set to turn on/off the wireless transmission module;
the wireless transmission module is electrically connected with the electromagnetic valve, and a size of a diameter of the electromagnetic valve while being turned on is set by a user with a mobile device so as to control a water flow; and
when the user wants to set the functions of the electronic faucet, the activation switch is pressed to turn on the wireless transmission module to transmit, receive, or process a setting order from the mobile device.

2. (canceled)

3. The activation device as claimed in claim 1, wherein the wireless transmission module is electrically connected with the sensor and having a storage unit.

4. The activation device as claimed in claim 1, wherein the activation switch is a reed switch.

5. (canceled)

6. The activation device as claimed in claim 1, wherein the activation switch is an electronic switch.

7. The activation device as claimed in claim 2, wherein the activation switch is an electronic switch.
